(19) United States
(12) Patent Application Publication
(10) Pub. No.: US 2011/0032055 A1
(43) Pub. Date: Feb. 10, 2011

(54) PRINTED CIRCUIT BOARD AND SIGNAL TRANSMISSION APPARATUS THEREOF

(75) Inventors: HSIAO-YUN SU, Tu-Cheng (TW); YU-CHANG PAI, Tu-Cheng (TW); SHOU-KUO HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/620,487

(22) Filed: Nov. 17, 2009

(30) Foreign Application Priority Data
Aug. 7, 2009 (CN) 200910305355.0

(51) Int. Cl. H01P 1/203

(52) U.S. Cl. 333/204; 333/4

(57) ABSTRACT

A signal transmission apparatus used in a printed circuit board (PCB). The apparatus includes a differential pair composed of two transmission lines arranged side by side in the PCB. The differential pair includes a filter section arranged therein to filter noise of transmission signals of the differential pair. The filter includes a number of section pairs connected in series. Each section pair includes two sections arranged in the two transmission lines symmetrically. Every two adjacent sections are different in line width. A distance between the two transmission lines, and the line width of each of the sections are predetermined according to desired frequency bandwidth, and desired frequency response of the differential pair.

### BACKGROUND

1. Technical Field

The present disclosure relates to signal transmission systems, and particularly to a signal transmission apparatus used in a signal receiver or a signal transceiver of a wireless transmission system.

2. Description of Related Art

Wireless transmission is widely used in communications and networks. Consequently, electronic devices can be moved freely without limitations of wires when transmitting signals. In a wireless transmission system, a signal for transmission is modulated by a high frequency carrier in a signal transceiver, to generate a radio frequency signal. The radio frequency signal is transmitted to a signal receiver via air, and is demodulated into the signal for transmission in the signal receiver. Bad signal quality may be induced if signal transmission paths of the radio frequency signal in the signal transceiver and the signal receiver are improperly designed.

### BRIEF DESCRIPTION OF THE DRAWINGS

FIG. 1 is an isometric view of a signal transmission apparatus according to an embodiment of the present disclosure, wherein the signal transmission apparatus includes a low pass filter.

FIG. 2 is an equivalent circuit diagram of the low pass filter of FIG. 1.

FIGS. 3, 4, and 5 respectively show simulation graphs of insertion loss of a difference-mode input for the signal transmission apparatus of FIG. 1 in different conditions.

### DETAILED DESCRIPTION

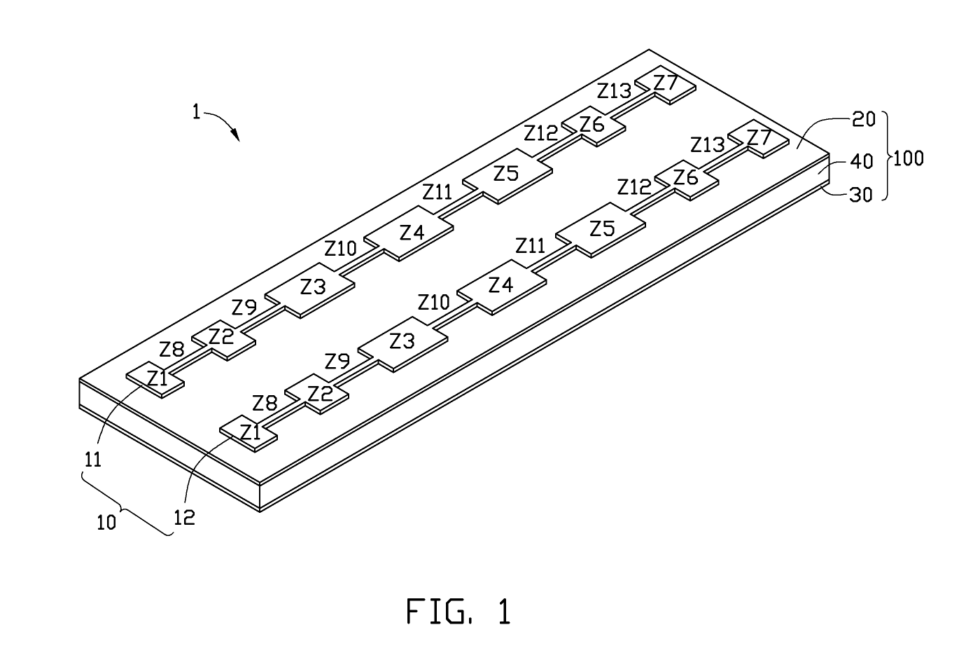

Referring to FIG. 1, an embodiment of a signal transmission apparatus 1 is used in a printed circuit board 100 which includes a signal layer 20, and a ground layer 30 adjacent to the signal layer 20. An insulating layer 40 made of glass fiber epoxy resin (FR-4) material is arranged between the signal layer 20 and the ground layer 30.

A differential pair 10 includes two transmission lines 11 and 12 is arranged in the signal layer 20. The transmission lines 11 and 12 are arranged side by side in the signal layer 20.

The differential pair 10 includes a plurality of section pairs arranged along a signal transmission direction of the differential pair 10. Each section pair includes a section arranged in the transmission line 41 and a section arranged in the transmission line 42. The two sections of each section pair are symmetrical with each other. Every two adjacent sections arranged in each of the transmission lines 41 and 42 are different in width.

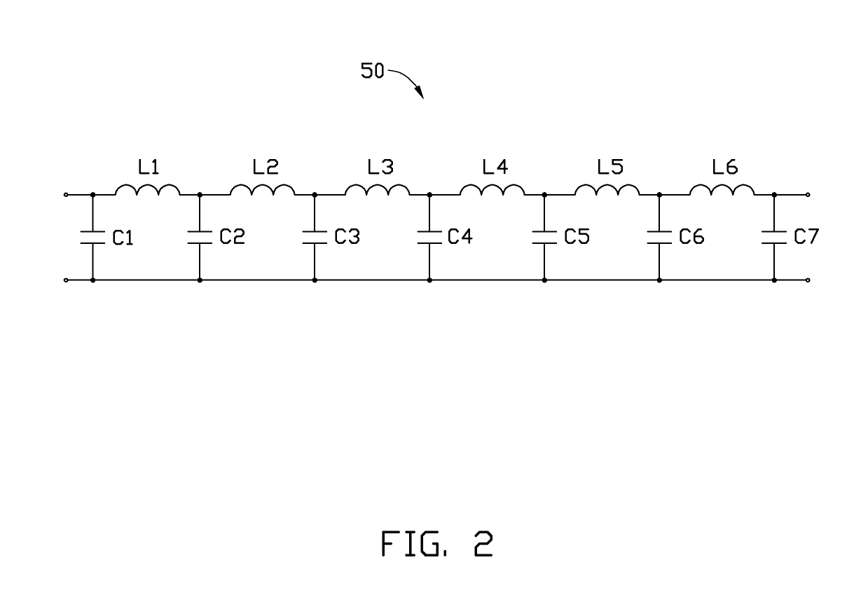

Referring to FIG. 2, it is known in the art that both inductance and capacitance of a transmission line are related to the width of the transmission line; the inductance increases with decreasing line width, and the capacitance increases with increasing line width. Therefore, the section pairs which have wide line width function as capacitors, and section pairs which have narrow line width function as inductors. All of the section pairs form a low pass filter. The number of the section pairs is chosen by required specifications of the low pass filter. As illustrated in this embodiment, the differential pair 10 includes thirteen section pairs Z1-Z13, which are designed according to a filter 50 as shown in FIG. 2.

The filter 50 includes seven capacitors C1-C7 and six inductors L1-L6. The section pairs Z1-Z7 are equivalent to the capacitors C1-C7 respectively. The section pairs Z8-Z13 are equivalent to the inductors L1-L6 respectively. The line width of each section of each of the section pairs Z1-Z13 is determined by parameters of a corresponding equivalent capacitor or inductor. The parameters may include a capacitance of each of the capacitors C1-C7 correspondingly or an inductance of each of the inductors L1-L6.

A length of each section of each of the section pairs Z1-Z7 is determined according to a first formula

$$C = \frac{l}{{Z}_{0} f {λ}_{g}} ,$$

and a length of each section of each of the section pairs Z8-Z13 is determined according to a second formula

$$L = \frac{{Z}_{0} l}{f {λ}_{g}} .$$

Where C is a capacitance of a corresponding one of the capacitors C1-C7, L is an inductance of a corresponding one of the inductors L1-L6, Z₀ is a desired characteristic impedance of a corresponding one of the section pairs Z1-Z13 under a desired frequency bandwidth, such as 3 gigahertzs (GHZ), of the differential pair 10, l is the length of each section of the corresponding one of the section pairs Z1-Z13, f is a cut-off frequency of the low pass filter 50, λ_{g} is a wavelength of signals transmitted on the differential pair 10 under the cut-off frequency. Values of the cut-off frequency and wavelength of the signals under the cut-off frequency are fixed. The capacitances of the capacitors C1-C7, the inductances of the inductors L1-L6 are predetermined. Therefore, the length of each section of each of the section pairs Z1-Z13 can be determined according the characteristic impedance of the section pairs Z1-Z13 correspondingly.

The desired characteristic impedances of each of the section pairs Z1-Z13 and the corresponding frequency bandwidth of the differential 10 can be achieved by simulating the apparatus 1 of FIG. 1 in a conventional simulation software, simulating the signal type to be transmitted through the transmission lines 11 and 12 and the desired characteristic impedance of each of the section pairs Z1-Z13, and adjusting a distance between the two transmission lines 11 and 12 without changing the line width of each section of the section pairs Z1-Z13, until the desired characteristic impedance of each of the section pairs Z1-Z13 is achieved. In this embodiment, the distance between the two transmission lines 11 and 12 is a distance between the two sections of each of the differential pairs Z1-Z7, which is adjusted by moving the transmission line 11 or the transmission line 12 along a direction perpendicular to the signal transmission direction. The desired characteristic impedance of each of the section pairs Z1-Z13 can also be achieved by adjusting the line width of each section of the section pairs Z1-Z7, or the line width of each section of the section pairs Z8-Z13.

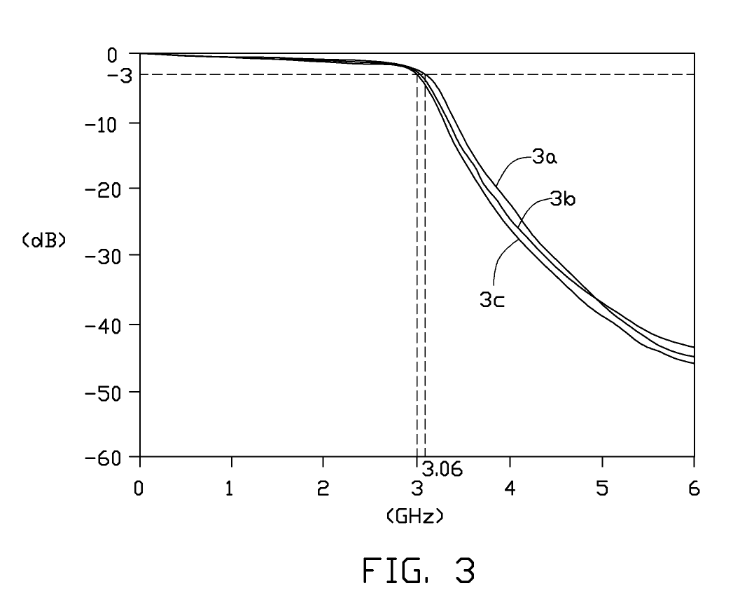

FIGS. 3, 4 and 5 are graphs showing insertion losses of a difference-mode input for the differential pair 10. Where curve 3a represents a simulation result of the differential pair 10 in a condition that the distance between the two transmission lines 11 and 12 is 50 mils, a line width of each section of the differential pairs Z1-Z7 is 99.73 mils, and a line width of each section of the section pairs Z8-Z13 is 9.324 mils. Curve 3b represents a simulation result of the differential pair 10 in a condition that the line width of each section of the differential pairs Z1-Z7 is changed to be 103.73 mils. Curve 3c represents a simulation result of the differential pair 10 in a condition that the line width of each section of the section pairs Z1-Z7 is changed to be 107.73 mils. The frequency bandwidth of the differential pair 10 is changed to be 3 GHZ from 3.06 GHZ in response to the line width of each section of the section pairs Z1-Z7 being adjusted to be 99.73 from 107.73 mils. Therefore, the required frequency bandwidth of the differential pair 10 can be achieved by adjusting the line width of each section of the section pairs Z1-Z7. It can also be determined from FIG. 3 that a frequency response of the differential pair 10 is changed since slops of the curves 3a-3c are different from one another.

Curve 4a represents a simulation result of the differential pair 10 in a condition that the distance between the two transmission lines 11 and 12 is 50 mils, the line width of each section of the differential pairs Z1-Z7 is 107.73 mils, and a line width of each section of the section pairs Z8-Z13 is 15.324 mils. In this condition, the frequency bandwidth of the differential pair 10 is 3.19 GHZ. Curve 4b and 4c respectively represents simulation results of the differential pair 10 in conditions that the line width of each section of the differential pairs Z8-Z13 decreases to be 12.324 mils and 9.324 mils. When the line width of each section of the differential pairs Z8-Z13 is adjusted to be 9.324 mils, the required 3 GHZ frequency bandwidth of the differential pair 10 is achieved. In addition, the frequency response is also changed. Therefore, both of the frequency bandwidth and the frequency response of the differential pair 10 can be adjusted by changing the line width of each section of the section pairs Z8-Z13.

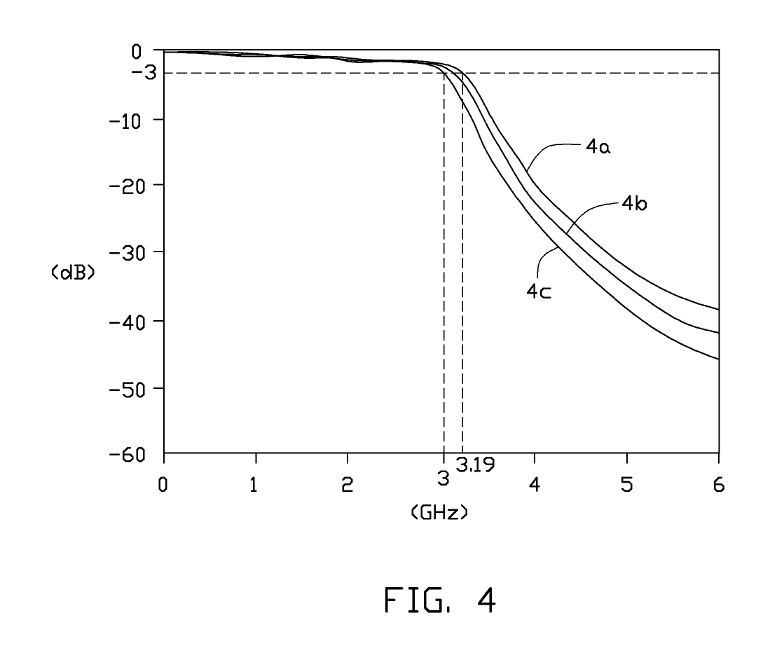

It can be determined from a comparison of FIGS. 3 and 4 that the frequency bandwidth and the frequency response of the differential pair 10 are more sensitive to the changing of the line width of each section of the section pairs Z8-Z13 than that the changing of the line width of each section of the section pairs Z1-Z7.

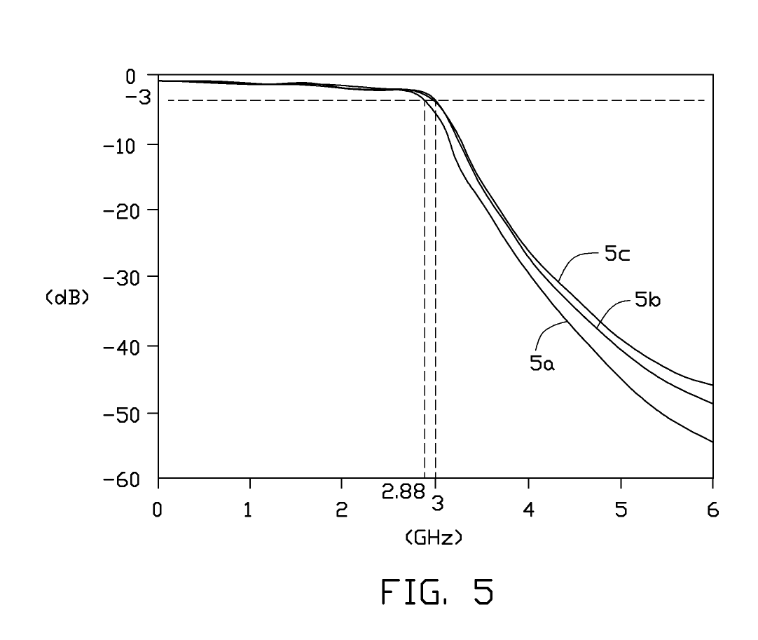

Curve 5a represents a simulation result of the differential pair 10 in a condition that the line width of each section of the differential pairs Z1-Z7 is 107.73 mils, and a line width of each section of the section pairs Z8-Z13 is 9.324 mils, and the distance between the two transmission lines 11 and 12 is 10 mils. In this condition, the frequency bandwidth of the differential pair 10 is 2.88 GHZ. Curves 5b and 5c respectively represent simulation results of the differential pair 10 in conditions that the distance between the two transmission lines 11 and 12 increases to be 30 mils and 50 mils. When the distance between the two transmission lines 11 and 12 is adjusted to be 50 mils, the required 3 GHZ frequency bandwidth of the differential pair 10 at a gain of −3 decibels (dB) is achieved. It can be determined from FIG. 5 that a better frequency response can be achieved when decreasing the distance between the two transmission lines 11 and 12.

Accordingly, required frequency bandwidth and frequency response of the differential pair 10 can be achieved by adjusting each of the distances between the two transmission lines 11 and 12, the line width of each section of the capacitance section pairs, and the line width of each section of the inductance section pairs. The signal transmission apparatus 1 can be used in wireless transmission devices, such as a wireless network card and an access point. The signal transmission apparatus 1 can also be used in wired transmission devices.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A signal transmission apparatus comprising:
a signal layer;
a ground layer;
an insulating layer arranged between the signal layer and the ground layer; and
a differential pair comprising a first transmission line and a second transmission line both arranged in the signal layer, wherein the differential pair comprises a plurality of section pairs, each of the plurality of section pairs comprises two sections arranged in the first and second transmission lines symmetrically, every two adjacent section pairs function as an inductor and a capacitor alternately, the differential pair has a desired frequency bandwidth at a corresponding gain value relative to a predetermined distance between the first and second transmission lines.

2. The apparatus of claim 1, wherein the predetermined distance between the first and second transmission lines is a distance between the two sections of each of the differential pairs which function as capacitors, the predetermined distance is obtained by moving the first transmission line or the second transmission line along a direction perpendicular to a signal transmission direction of the differential pair.

3. The apparatus of claim 1, wherein the plurality of section pairs form a filter.

4. The apparatus of claim 3, wherein a length of each section of the section pairs which function as capacitors is determined according to a first formula
$$C = \frac{l}{{Z}_{0} f {λ}_{g}} ,$$
and a length of each section of the section pairs which function as inductors is determined according to a second formula
$$L = \frac{{Z}_{0} l}{f {λ}_{g}} ,$$
where C is a capacitance of each of the capacitors, L is an inductance of each of the inductors, Z₀ is a desired characteristic impedance of each of the plurality of section pairs corresponding to the desired frequency bandwidth of the differential pair, l is the length of each section of each of the plurality of section pairs, f is a cut-off frequency of the filter, λ_{g} is a wavelength of signals transmitted on the differential pair under the cut-off frequency.

5. The apparatus of claim 1, wherein the insulating layer is made of glass fiber epoxy resin (FR-4) material.

6. The apparatus of claim 1, wherein the desired frequency bandwidth of the differential pair is further relative to a line width of each section of the section pairs which function as capacitors, and a line width of each section of the section pairs which function as inductors.

7. A printed circuit board (PCB), comprising:
a differential pair comprising two transmission lines arranged side by side;
a filter section arranged in the differential pair to filter noise of signals transmitted through the differential pair; wherein
a distance between the two transmission lines changes with desired frequency bandwidth and desired frequency response of the differential pair.

8. The PCB of claim 7, wherein the filter section comprises a plurality of sections pairs connected in series, each section pair comprises two sections arranged in the first and second transmission lines symmetrically, every two adjacent sections are different in width, the section pair having wider sections functions as a capacitor and the section pair having narrower sections functions as an inductor.

9. The PCB of claim 7, wherein the distance between the two transmission lines is changed by moving at least one of the two transmission lines along a direction perpendicular to a signal transmission direction of the differential pair.

10. A printed circuit board comprising:
a signal layer, wherein a differential pair comprising two transmission lines is arranged in the signal layer, the differential pair comprises a filter arranged therein, the filter comprises a plurality of section pairs connected in series, each of the plurality of section pairs comprises two sections arranged in the two transmission lines symmetrically, every two adjacent sections are different in line width; and
a ground layer adjacent to and insulated from the signal layer; wherein
a distance between the two transmission lines, and the line width of each of the sections are predetermined according to desired frequency bandwidth and desired frequency response of the differential pair.
